(19) United States
(12) Patent Application Publication
(10) Pub. No.: US 2026/0212747 A1
(43) Pub. Date: Jul. 23, 2026

(54) METHOD AND SYSTEM FOR PROVIDING A THERMAL PROPAGATION WARNING FOR A BATTERY FOR AN ELECTRIC AUTOMOTIVE VEHICLE

(71) Applicant: FCA US LLC, Auburn Hills, MI (US)

(72) Inventors: Huan Ma, Shanghai (CN); Gang Wang, Shanghai (CN); Shufei Huang, Shanghai (CN); Lin Wang, Shanghai (CN); Yabin Fan, Shanghai (CN)

(21) Appl. No.: 19/034,828

(22) Filed: Jan. 23, 2025

(51) Int. Cl. G08B 21/18; B60L 3/00; H01M 10/48; H01M 50/204; H01M 50/249

(52) U.S. Cl. CPC G08B 21/182; B60L 3/0046; H01M 10/482; H01M 50/204; H01M 50/249; H01M 2220/20

(57) ABSTRACT

A warning system for a battery pack of a vehicle and a method for operating the same includes melting a phase change material in a phase change housing above a temperature threshold. In response to melting, extending a push rod from the housing. The method further includes electrically coupling a static contactor and a dynamic contactor. In response to electrically coupling, an alarm is activated.

### FIELD

The present disclosure relates an electric vehicle, and, more specifically, to a method and system for providing a thermal propagation warning for a battery for an electric automotive vehicle.

### BACKGROUND

This section provides background information related to the present disclosure which is not necessarily prior art.

Thermal propagation from a battery can occur during operation or when the vehicle is stationary. Currently, vehicles do not include warnings for thermal propagation when the vehicle is at rest.

### SUMMARY

This section provides a general summary of the disclosure and is not a comprehensive disclosure of its full scope or all of its features.

The present system and method provide a system and method for providing an alarm when thermal propagation occurs in the battery. The system is particularly useful for when the vehicle is not being operated.

In one aspect of the disclosure, a warning system includes an alarm, a power supply coupled to the alarm and a thermal phase change switch coupled to the alarm and the power supply. The thermal phase change switch includes a switch housing, a phase change housing disposed within the switch housing. The phase change housing enclosing a phase change material having a solid phase below a temperature threshold and a non-solid phase above the temperature threshold. A static contactor is electrically coupled to the power supply and alarm. A dynamic contactor is electrically coupled to the power supply and alarm. The dynamic contactor comprises a first position electrically decoupled from the static contactor and a second position electrically coupled to the static contactor to allow the alarm to operate. A push rod has a first end disposed in the phase change housing and a second end operably coupled to the dynamic contactor. A spring is coupled to the push rod. The spring pushes the push rod to move the push rod into the dynamic contactor to obtain the second position when the phase change material is in the non-solid phase.

In another aspect of the disclosure, a method for operating a warning system includes melting a phase change material in a phase change housing above a temperature threshold. In response to melting, extending a push rod from the housing. The method further includes electrically coupling a static contactor and a dynamic contactor. In response to electrically coupling, an alarm is activated.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a high level block diagrammatic view of a vehicle.

FIG. 2 is a block diagrammatic view of a battery pack having a warning system according to the present disclosure.

FIG. 3A is a schematic cross-sectional view of a thermal phase change switch in an opened position within the warning system.

FIG. 3B is a schematic cross-sectional view of the switch in a closed position within the warning system.

FIG. 3C is an enlarged view of the pivot point of FIG. 3C.

FIG. 3D is an alternate view of the dynamic contactor with sliding attachment.

FIG. 4 is a flowchart of a method for operating the system.

Corresponding reference numerals indicate corresponding parts throughout the several views of the drawings.

### DETAILED DESCRIPTION

Example embodiments will now be described more fully with reference to the accompanying drawings.

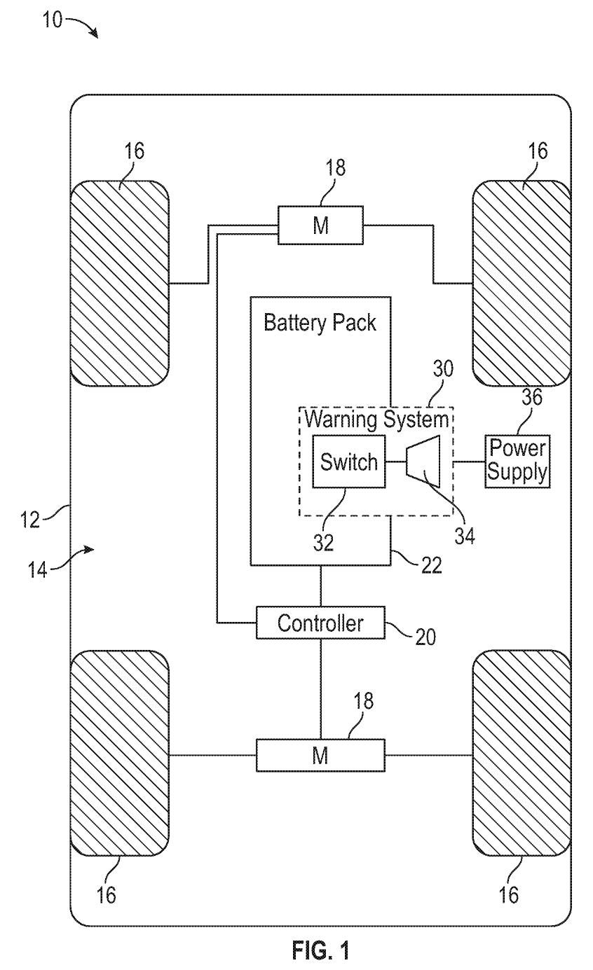

Referring now to FIG. 1, a simplified vehicle 10 is illustrated having a body 12 that defines a passenger compartment 14. The vehicle 10 has wheels/tires 16 that move the vehicle 10 in the desired direction.

The wheels/tires 16 are coupled to one or more motors 18. The motors 18 are electric motors that are controlled by a controller 20. The controller 20 controls the application of and the amount of power to the motors 18 from a high-voltage battery pack 22. The controller 20 coordinates the operation of the motors 18 to drive the wheel/tires 16 in the desired direction and speed.

The battery pack 22 may be referred to as a traction battery. The battery pack 22 may have one or more warning systems 30 coupled thereto. The warning system 30 includes a thermal phase change switch 32 coupled to an alarm 34. As will be described in greater detail below, when thermal propagation occurs in the battery pack 22, the warning system 30 generates an alarm signal by electrically coupling the switch 32, a power supply 36 and the alarm 34 to form a complete circuit. The power supply 36 may be a 12 volt power supply located outside of the battery pack 22.

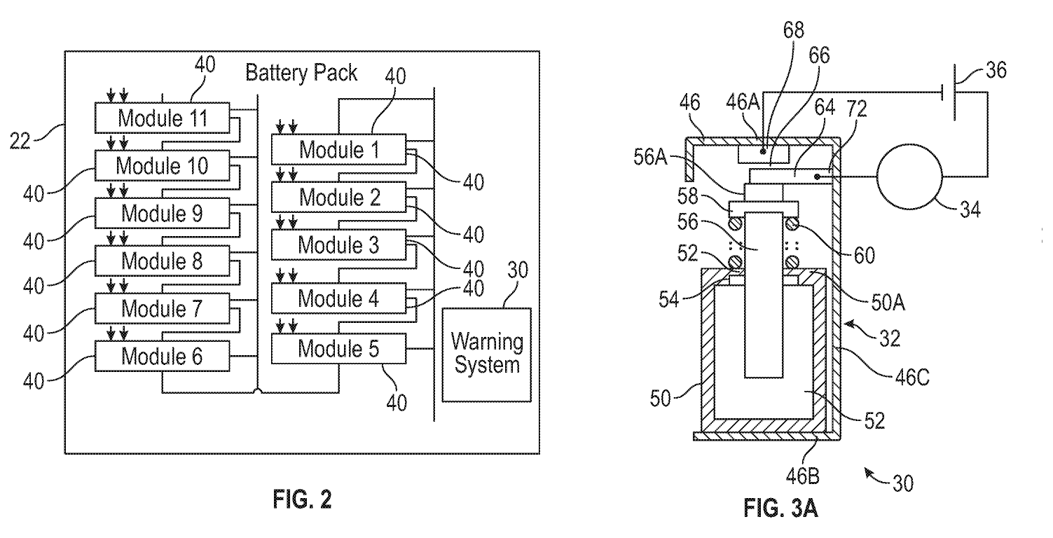

Referring now to FIG. 2, the battery pack 22 is illustrated in further detail. The battery pack 22 may have a plurality of battery modules 40 disposed therein. The modules 40 may be disposed in a single or multiple battery pack housings. Although one warning system 30 is illustrated coupled to “module 5”, a plurality of warning systems 30 may be used in a system. One warning system may be coupled to each module or multiple modules may be coupled to a single warning system.

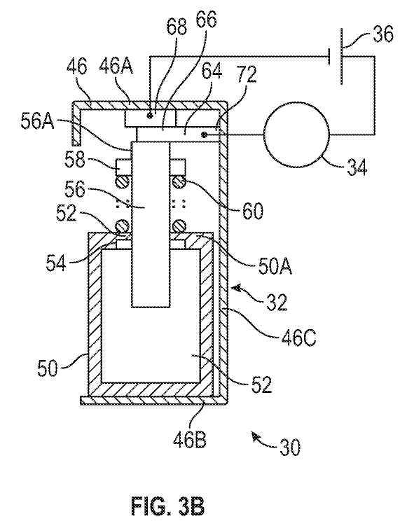

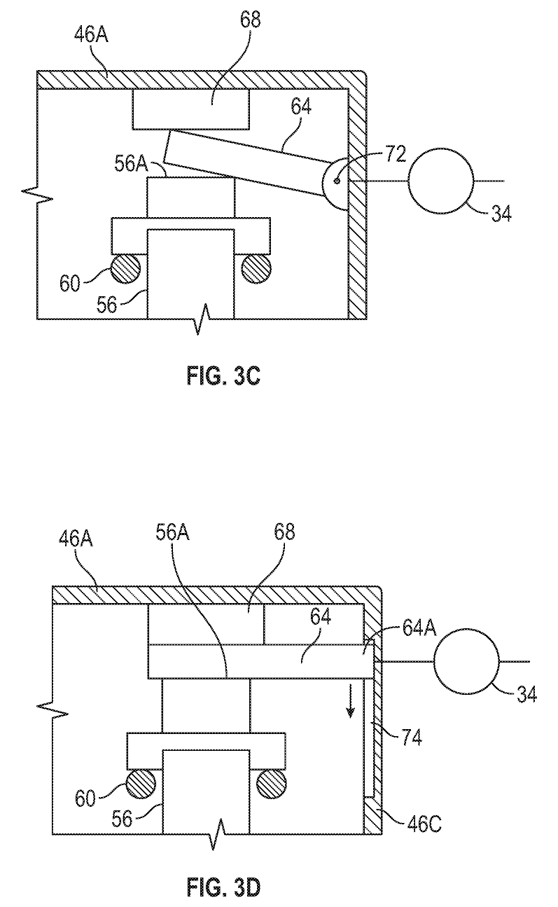

Referring now to FIG. 3A, the warning system 30 is illustrated in greater detail. The warning system 30 has the alarm 34 and the power supply 36 coupled in series. The thermal phase change switch 32 selectively opens and closes so that the alarm 34 is triggered when thermal propagation is detected.

The switch 32 comprises a switch housing 46. In the present example, the switch housing 46 is not fully enclosed. However, the switch housing 46 may fully enclose the components therein. In the present example, the switch housing 46 has an upper wall 46A and a lower wall 46B. A side wall 46C is disposed between the upper wall 46A and the lower wall 46B. The switch housing 46 may be disposed within the vehicle and the upper wall 46A and the lower wall 46B are relative to the normal operating position of the vehicle. The housing 46A has a phase change housing 50. The phase change housing 50 is a generally enclosed housing. The housing 50 has a multiple sides and is used to house or enclose a phase change material 52 such as paraffin therein. The paraffin or other phase change material 52 has a solid phase below a temperature threshold and a non-solid phase above the temperature threshold. The phase change material 52 may be chemically adjusted to have the desired temperature threshold. In one example, the temperature threshold is 60 Celsius. The housing 50 has an upper wall 50A that has an opening 53. The opening 53 is sealed by a seal gasket 54. The seal gasket 54 prevents non-solid phase change material from leaking therefrom in the non-solid phase. The gasket 54 and the opening 53 has a push rod 56 extend therefrom. In FIG. 3A, the push rod is disposed in a lower position. The push rod 56 has a spring rest 58 that extends radially therefrom. The spring rest 58 is fixedly coupled to the push rod 56. A coil spring 60 is disposed around the push rod 56 and is illustrated in a compressed position in FIG. 3A.

The push rod 56 and the top surface 56A thereof is directly adjacent to a dynamic contactor 64. In the electrical circuit, the dynamic contactor 64, in this example, is directly adjacent to the alarm 34. However, there is a gap 66 between the dynamic contactor 64 and a static contactor 68. The static contactor 68 is disposed in series with the power supply 36 and the alarm 34. Because of the gap 66, no electrical current is flowing to the alarm 34 from the power supply 36 and thus, the alarm is not sounding when the dynamic contactor 64 is in the first position. That is, both of the push rod 56 and the dynamic contactor 64 are in a first position so the contactors are electrically decoupled. It should be noted that the dynamic contactor 64 is pivotally coupled to the side wall 46C at a pivot point 72.

In this example, the phase change material 52 is in a solid state and below the temperature threshold holding the rod 56 in a lowermost position while the spring 60 is in a compressed mode. The phase change material is strong enough to hold the push rod 56 to resist the upward spring force and maintain the contactors in a decoupled state.

Referring now to FIGS. 3B and 3C, the thermal phase change switch 32 is in a second position with the spring 60 in a less compressed mode. The spring 60 pushes the push rod 56 upward by way of the spring rest 58. The phase change material 52 is in a non-solid state. The phase change material 52 may be in a liquid state above the temperature threshold. However, a non-liquid state implies that the phase change liquid is less solid and may be in a gel-like form to allow the spring force of the spring 60 to overcome the gripping force by the phase change material 52. In this example, the push rod 56 pushes the dynamic contactor 64 upward toward the static contactor 68 so that electrical current flows from the power supply 36 through the alarm 34, through the dynamic contactor 64 and the static contactor 68. Because of the flow of current, the alarm 34 will sound. The circuit illustrated in FIGS. 3A and 3B are not dependent on any other components of the vehicle except for the battery or power source 36 which may be a 12 volt battery within the vehicle.

Referring now to FIG. 3D, the dynamic contactor 64 may have an end 64A slidably engaged in a channel 74 within a side wall 46C. As the push rod 56 moves, the dynamic contact 64 moves therewith.

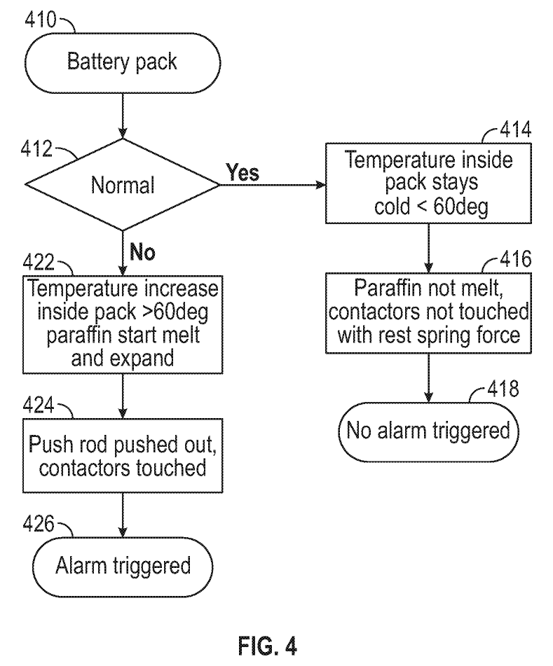

Referring now to FIG. 4, a method for operating the warning system is set forth. In step 410, the battery pack is operated. The present system may be used when the battery pack is idle or not being operated.

In step 412 if no thermal propagation is detected, the system is determined to be normal. When the system is normal, the temperature inside the battery pack stays at a colder temperature, such as below 60 degrees, in step 414. In step 416, the phase change material, such as paraffin, is not melted and the contactors are not touched with the spring in a compressed position. Therefore, in step 418, no alarm is activated or triggered.

Referring back to step 412, when the operation is not normal, the temperature inside the battery pack is greater than 60 degrees, in this example, and the phase change material, such as the paraffin, starts to melt and expand. In step 424, the push rod is pushed out so that the dynamic contactor and the static contactor are coupled together. This closes the circuit and allows current to flow therethrough. The current activates the alarm in step 426.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms "a,” "an," and "the" may be intended to include the plural forms as well, unless the context clearly indicates otherwise. The terms "comprises," "comprising," “including,” and “having,” are inclusive and therefore specify the presence of stated features, integers, steps, operations, elements, and/or components, but do not preclude the presence or addition of one or more other features, integers, steps, operations, elements, components, and/or groups thereof. 1steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being "on," “engaged to,” "connected to," or "coupled to" another element or layer, it may be directly on, engaged, connected or coupled to the other element or layer, or intervening elements or layers may be present. In contrast, when an element is referred to as being "directly on," “directly engaged to,” "directly connected to," or "directly coupled to" another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term "and/or" includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” "beneath," "below," "lower," "above," "upper," and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as "below" or "beneath" other elements or features would then be oriented "above" the other elements or features. Thus, the example term "below" can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A warning system comprising:
an alarm;
a power supply coupled to the alarm;
a thermal phase change switch coupled to the alarm and the power supply, the thermal phase change switch comprising,
a switch housing;
a phase change housing disposed within the switch housing, the phase change housing enclosing a phase change material having a solid phase below a temperature threshold and a non-solid phase above the temperature threshold;
a static contactor electrically coupled to the power supply and alarm;
a dynamic contactor electrically coupled to the power supply and alarm, the dynamic contactor comprising a first position electrically decoupled from the static contactor and a second position electrically coupled to the static contactor to allow the alarm to operate;
a push rod having a first end disposed in the phase change housing and a second end operably coupled to the dynamic contactor; and
a spring coupled to the push rod, the spring pushing the push rod to move the push rod into the dynamic contactor to obtain the second position when the phase change material is in the non-solid phase.

2. The warning system of claim 1 wherein the alarm, the power supply and the thermal phase change switch are in series.

3. The warning system of claim 1 wherein the phase change housing comprises an upper wall, said spring continually adjacent to the upper wall when the dynamic contactor is in the first position and the second position.

4. The warning system of claim 1 wherein the phase change housing comprises an upper wall, push rod slidably coupled through an opening of the upper wall.

5. The warning system of claim 4 wherein the upper wall comprises a seal gasket disposed within the opening.

6. The warning system of claim 1 wherein the phase change housing comprises an upper wall, said spring adjacent to the upper wall.

7. The warning system of claim 1 wherein the phase change material comprises paraffin.

8. The warning system of claim 1 wherein the push rod comprises a spring rest extending radially therefrom.

9. The warning system of claim 8 wherein the spring rest is adjacent to the spring.

10. The warning system of claim 1 wherein the switch housing comprises an upper wall, said static contactor is coupled to the upper wall.

11. The warning system of claim 1 wherein the switch housing comprises a side wall, said dynamic contactor is movably coupled to the side wall.

12. The warning system of claim 1 wherein the switch housing comprises a side wall, said dynamic contactor is rotatably coupled to the side wall.

13. The warning system of claim 1 wherein the switch housing comprises an upper wall, said static contactor is coupled to the upper wall and, the switch housing comprises a side wall, said dynamic contactor is movably coupled to the side wall.

14. A battery pack comprising;
a plurality of battery modules; and
the warning system of claim 1 operably coupled to at least one of the plurality of battery modules.

15. A vehicle comprising:
a vehicle body; and
the battery pack of claim 14 coupled to the vehicle body.

16. A method of operating a warning system for a battery pack of a vehicle comprising:
melting a phase change material in a phase change housing above a temperature threshold;
in response to melting extending a push rod;
electrically coupling a static contactor and a dynamic contactor; and
in response to electrically coupling, activating an alarm.

17. The method of claim 16 wherein activating the alarm comprises electrically coupling a power source to the alarm.

18. The method of claim 16 wherein extending the push rod comprise pushing the push rod from a phase change housing using a spring.

19. The method of claim 18 wherein pushing comprises pushing a spring against an upper wall of the phase change housing and a spring rest.

20. The method of claim 19 further comprising wherein pushing further comprises pushing, by way of the push rod a dynamic contact against a static contact disposed in a switch housing.
